(19) United States
(12) Patent Application Publication
(10) Pub. No.: US 2021/0117793 A1
(43) Pub. Date: Apr. 22, 2021

(54) DATA PROCESSING SYSTEM AND DATA PROCESSING METHOD

(71) Applicant: OLYMPUS CORPORATION, Tokyo (JP)

(72) Inventor: Yoichi YAGUCHI, Tokyo (JP)

(73) Assignee: OLYMPUS CORPORATION, Tokyo (JP)

(21) Appl. No.: 17/133,402

(22) Filed: Dec. 23, 2020

Related U.S. Application Data
(63) Continuation of application No. PCT/JP2018/024645, filed on Jun. 28, 2018.

(51) Int. Cl. G06N 3/08; G06N 3/04

(52) U.S. Cl. CPC G06N 3/08; G06K 9/6217; G06N 3/04

(57) ABSTRACT

A data processing system includes: a neural network processing unit that performs processing based on a neural network including an input layer, at least one intermediate layer, and an output layer; and a learning unit that optimizes an optimization target parameter in the neural network, based on a comparison between output data output after the neural network processing unit performs processing on learning data based on the neural network and ideal output data for the learning data. When intermediate data represent input data to an intermediate layer element constituting an Mth intermediate layer or output data from the intermediate layer element, the neural network processing unit performs disturbance processing of applying, to each of N intermediate data based on a set of N learning samples included in learning data, an operation using at least one intermediate datum selected from among the N intermediate data, where M is an integer greater than or equal to 1, and N is an integer greater than or equal to 2.

### CROSS-REFERENCE TO RELATED APPLICATIONS

This application is based upon and claims the benefit of priority from International Application No. PCT/JP2018/024645, filed on Jun. 28, 2018, the entire contents of which is incorporated herein by reference.

### BACKGROUND OF THE INVENTION

### 1. Field of the Invention

The present invention relates to a data processing system and a data processing method.

### 2. Description of the Related Art

Neural networks are mathematical models including one or more non-linear units and are also machine learning models used to estimate outputs corresponding to inputs. Many neural networks include one or more intermediate layers (hidden layers) besides an input layer and an output layer. The output of each intermediate layer is provided as an input to the next layer (another intermediate layer or the output layer). In each layer of a neural network, an output is generated based on the input and a parameter in the layer.

As a problem in neural network learning, overfitting to learning data is known. The overfitting to learning data causes degradation of estimation accuracy for unknown data.

### SUMMARY OF THE INVENTION

The present invention has been made in view of such a situation, and a purpose thereof is to provide a technology for restraining overfitting to learning data.

To solve the problem above, a data processing system according to one aspect of the present invention includes: a neural network processing unit that performs processing based on a neural network including an input layer, at least one intermediate layer, and an output layer; and a learning unit that optimizes an optimization target parameter in the neural network, based on a comparison between output data output after the neural network processing unit performs processing on learning data and ideal output data for the learning data. When intermediate data represent input data to an intermediate layer element constituting an Mth intermediate layer or output data from the intermediate layer element, the neural network processing unit performs disturbance processing of applying, to each of N intermediate data based on a set of N learning samples included in learning data, an operation using at least one intermediate datum selected from among the N intermediate data, where M is an integer greater than or equal to 1, and N is an integer greater than or equal to 2.

Optional combinations of the aforementioned constituting elements, and implementation of the present invention in the form of methods, apparatuses, systems, recording media, and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram that shows functions and a configuration of a data processing system according to an embodiment;

FIG. 2 schematically shows an example of a neural network configuration;

FIG. 3 is a flowchart of learning processing performed in the data processing system;

FIG. 4 is a flowchart of application processing performed in the data processing system; and

FIG. 5 schematically shows another example of the neural network configuration.

### DETAILED DESCRIPTION OF THE INVENTION

The invention will now be described by reference to the preferred embodiments. This does not intend to limit the scope of the present invention, but to exemplify the invention.

In the following, the present invention will be described based on a preferred embodiment with reference to the drawings.

Before description of the embodiment is given, the base findings will be described.

If only learning data are learned in neural network learning, a complex mapping that overfits the learning data will be obtained because neural networks have numerous parameters to be optimized. In general data amplification, overfitting can be moderated by adding perturbation to geometric shapes, values, or the like in the learning data. However, since only the vicinity of each learning datum is filled with the perturbation data, the effect provided thereby is limitative. In the between-class learning, two learning data and ideal output data corresponding respectively thereto are mixed with an appropriate ratio, thereby amplifying the data. Accordingly, the learning data space and the output data space are densely filled with pseudo data, so that overfitting can be restrained more effectively. Meanwhile, learning is performed such that, in a representation space in an intermediate part of a network, data to be learned can be represented with a large distribution. Therefore, the present invention proposes a method for improving the representation space in the intermediate part by mixing data in many intermediate layers from a layer closer to the input to a layer closer to the output. The method also restrains overfitting to learning data in the network as a whole. In the following, a specific description will be given.

There will now be described the case of applying a data processing device to image processing as an example. It will be understood by those skilled in the art that the data processing device is also applicable to speech recognition processing, natural language processing, and other processes.

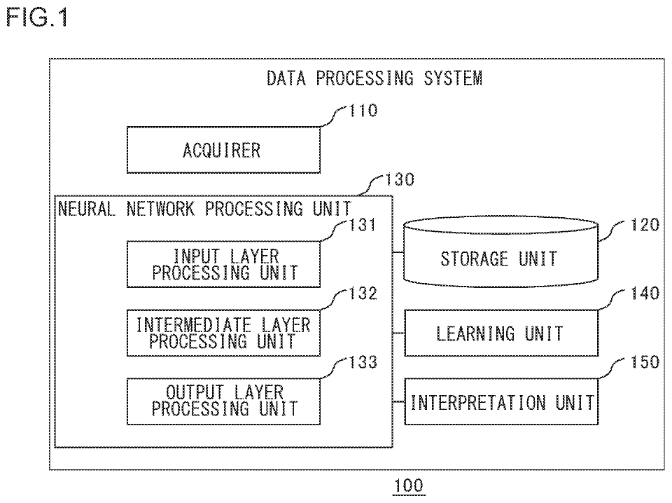

FIG. 1 is a block diagram that shows functions and a configuration of a data processing system 100 according to an embodiment. Each block shown therein can be implemented by an element such as a central processing unit (CPU) of a computer or by a mechanism in terms of hardware, and by a computer program or the like in terms of software. FIG. 1 illustrates functional blocks implemented by the cooperation of those components. Therefore, it will be understood by those skilled in the art that these functional blocks may be implemented in a variety of forms by combinations of hardware and software.

The data processing system 100 performs “learning processing” in which neural network learning is performed based on a learning image (learning data) and a correct value as ideal output data for the learning image, and also performs “application processing” in which a learned neural network is applied to an unknown image (unknown data), and image processing, such as image classification, object detection, or image segmentation, is performed.

In the learning processing, the data processing system 100 performs processing on a learning image based on the neural network and outputs output data for the learning image. The data processing system 100 also updates a parameter to be optimized (learned) (hereinafter, referred to as an “optimization target parameter”) in the neural network such that the output data become closer to the correct value. Repeating these steps can optimize the optimization target parameter.

In the application processing, the data processing system 100 performs processing on an image based on the neural network by using the optimization target parameter optimized in the learning processing, and outputs output data for the image. The data processing system 100 interprets the output data to classify the image, detect an object from the image, or perform image segmentation on the image, for example.

The data processing system 100 includes an acquirer 110, a storage unit 120, a neural network processing unit 130, a learning unit 140, and an interpretation unit 150. The neural network processing unit 130 and the learning unit 140 mainly implement the learning processing functions, and the neural network processing unit 130 and the interpretation unit 150 mainly implement the application processing functions.

In the learning processing, the acquirer 110 acquires a set of N learning images (learning samples) and N correct values corresponding respectively to the N learning images, where N is an integer greater than or equal to 2. In the application processing, the acquirer 110 acquires an image to be processed. The number of channels of the image is not particularly specified, and the image may be an RGB image, or may be a grayscale image.

The storage unit 120 stores images acquired by the acquirer 110 and also serves as work areas for the neural network processing unit 130, learning unit 140, and the interpretation unit 150, and as a storage area for neural network parameters.

The neural network processing unit 130 performs processing based on the neural network. The neural network processing unit 130 includes an input layer processing unit 131 that performs processing for an input layer, an intermediate layer processing unit 132 that performs processing for an intermediate layer (a hidden layer), and an output layer processing unit 133 that performs processing for an output layer in the neural network.

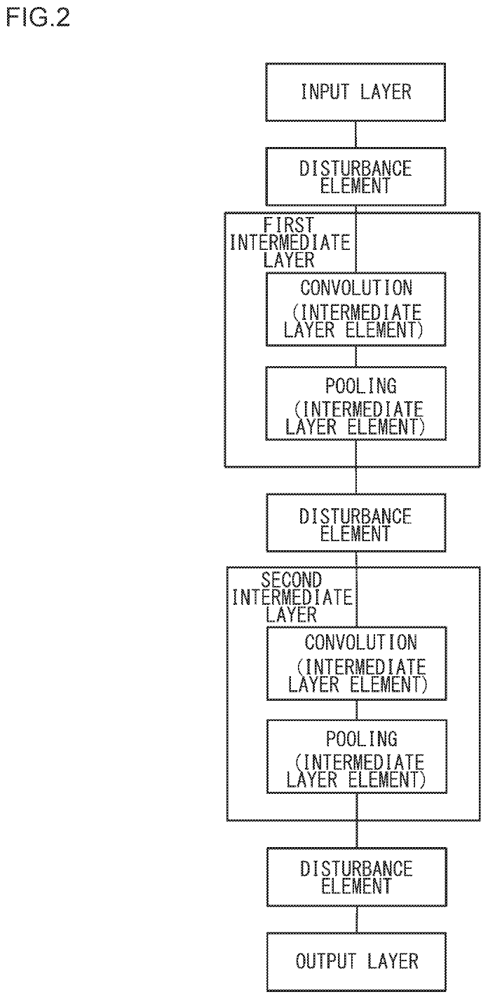

FIG. 2 schematically shows an example of a neural network configuration. In this example, the neural network includes two intermediate layers, and each intermediate layer is configured to include an intermediate layer element in which convolution processing is performed, and an intermediate layer element in which pooling processing is performed. The number of intermediate layers is not particularly limited, and the number may be one, or may be three or more, for example. In the illustrated example, the intermediate layer processing unit 132 performs processing for each element in each intermediate layer.

In the present embodiment, the neural network includes at least one disturbance element. In the illustrated example, the neural network includes a disturbance element at each of the preceding position and the subsequent position of each intermediate layer. In a disturbance element, the intermediate layer processing unit 132 performs processing for the disturbance element.

In the learning processing, the intermediate layer processing unit 132 performs disturbance processing as the processing for the disturbance element. When intermediate data represent input data to an intermediate layer element or output data from an intermediate layer element, the disturbance processing means processing for applying, to each of N intermediate data based on N learning images included in a set of learning images, an operation using at least one intermediate datum selected from among the N intermediate data.

More specifically, the disturbance processing is given by Formula (1) below, for example.

y=x+r⊙ shuffle(x) (1)

x: INPUT

y: OUTPUT

r: GAUSSIAN RANDOM VECTOR SUCH THAT r ∈ N(μ, σ²)

⊙: MULTIPLICATION IN UNITS OF IMAGES

shuffle(⋅) OPERATION FOR RANDOMLY REARRANGING THE ORDER ALONG AN IMAGE AXIS

In this example, each of N learning images included in a set of learning images is used for disturbance to another image among the N learning images. Also, with each of the N learning images, another image is linearly combined.

In the application processing, the intermediate layer processing unit 132 performs, as the processing for a disturbance element, processing given by Formula (2) below, which is processing of outputting the input as it is, instead of the disturbance processing, i.e., without performing the disturbance processing.

y=x (2)

The learning unit 140 optimizes an optimization target parameter in the neural network. The learning unit 140 calculates an error based on an objective function (error function) for comparing the output obtained by inputting a learning image to the neural network processing unit 130 and a correct value corresponding to the image. Based on the error thus calculated, the learning unit 140 calculates a gradient for a parameter using gradient backpropagation or the like, and updates an optimization target parameter in the neural network based on the momentum method.

A partial differential with respect to the vector x in the disturbance processing used in backpropagation is given by Formula (3) below.

gₓ=g_{y}+unshuffle(r ⊙ g_{y}) (3)
gₓ:PARTIAL DIFFERENTIAL OF OUTPUT ERROR FUNCTION WITH RESPECT TO x
g_{y}:PARTIAL DIFFERENTIAL OF OUTPUT ERROR FUNCTION WITH RESPECT TO y

unshuffle(⋅): INVERSE OPERATION OF shuffle(⋅)

By repeating the acquiring of a learning image by the acquirer 110, the processing on the learning image based on the neural network performed by the neural network processing unit 130, and the updating of an optimization target parameter performed by the learning unit 140, the optimization target parameter can be optimized.

The learning unit 140 also determines whether or not to terminate the learning. The termination conditions for terminating the learning may include: the learning having been performed a predetermined number of times, a termination instruction having been received from the outside, an average value of updated amounts of an optimization target parameter having reached a predetermined value, and a calculated error having fallen within a predetermined range, for example. When a termination condition is satisfied, the learning unit 140 terminates the learning processing. When any termination condition is not satisfied, the learning unit 140 returns the process to the neural network processing unit 130.

The interpretation unit 150 interprets the output from the output layer processing unit 133 to perform image classification, object detection, or image segmentation.

There will now be described an operation performed by the data processing system 100 according to the embodiment.

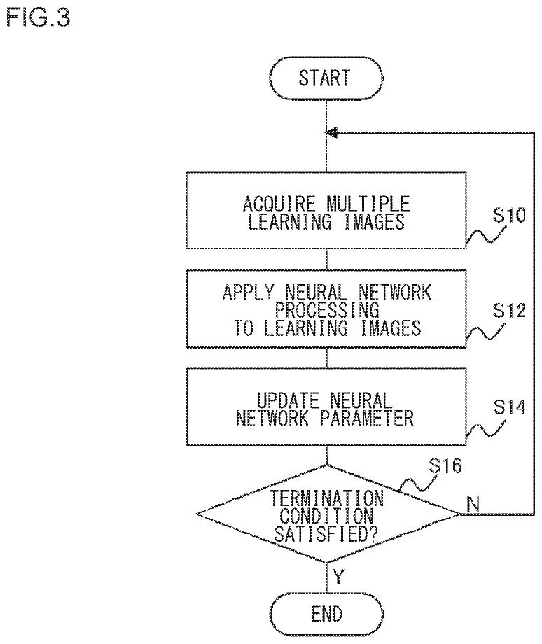

FIG. 3 is a flowchart of learning processing performed in the data processing system 100. The acquirer 110 acquires multiple learning images (S10). On each of the multiple learning images acquired by the acquirer 110, the neural network processing unit 130 performs processing based on a neural network, and outputs output data for the each learning image (S12). Based on the output data for each of the multiple learning images and a correct value for the each learning image, the learning unit 140 updates a parameter (S14). The learning unit 140 determines whether or not a termination condition is satisfied (S16). If any termination condition is not satisfied (N at S16), the process returns to S10. If a termination condition is satisfied (Y at S16), the process terminates.

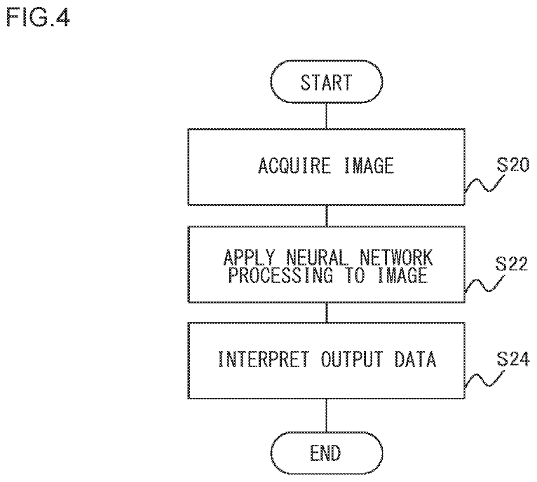

FIG. 4 is a flowchart of application processing performed in the data processing system 100. The acquirer 110 acquires an image for the application processing (S20). On the image acquired by the acquirer 110, the neural network processing unit 130 performs processing based on the neural network of which the optimization target parameter has been optimized, i.e., learned, and outputs output data (S22). The interpretation unit 150 interprets the output data to classify the subject image, detect an object from the subject image, or perform image segmentation on the subject image, for example (S24).

With the data processing system 100 according to the embodiment set forth above, disturbance to each of N intermediate data based on N learning images included in a set of learning images is performed using at least one intermediate datum selected from among the N intermediate data, i.e., a homogeneous datum. Such disturbance using homogeneous data leads to rational expansion of data distribution, thereby restraining overfitting to learning data.

Also, with the data processing system 100, each of N learning images included in a set of learning images is used for disturbance to another image among the N learning images. Accordingly, all the data can be learned uniformly.

Also, with the data processing system 100, since the disturbance processing is not performed in the application processing, the application processing can be performed within the process time similar in length to that in the case where the present invention is not used.

The present invention has been described with reference to an embodiment. The embodiment is intended to be illustrative only, and it will be obvious to those skilled in the art that various modifications to a combination of constituting elements or processes could be developed and that such modifications also fall within the scope of the present invention.

### First Modification

In the learning processing, disturbance to each of N intermediate data based on N learning images included in a set of learning images has only to be performed using at least one intermediate datum selected from among the N intermediate data, i.e., a homogeneous datum, and various modifications may be considered. In the following, some modifications will be described.

The disturbance processing may be given by Formula (4) below.

$$\begin{matrix}y = ( 1 - r ) ⊙ x + r ⊙ shuffle ( x ) & ( 4 ) \\ 1 \text{:} VECTOR OF WHICH ALL THE ELEMENTS ARE \\ 1 ( HAVING THE SAME LENGTH AS r ) & \end{matrix}$$

In this case, a partial differential with respect to the vector x in the disturbance processing used in backpropagation is given by Formula (5) below.

gₓ=(1−r) ⊙ g_{y}+unshuffle(r ⊙ g_{y}) (5)

Also, the processing performed as the processing for a disturbance element in the application processing, i.e., the processing performed instead of the disturbance processing, is given by Formula (6) below. As the scale is aligned, image processing accuracy in the application processing is improved.

$$\begin{matrix}y = ( 1 - E [ r ] ) x & ( 6 ) \\ EXPECTED VALUE OF E [ r ] \text{:} r ∈ r & \end{matrix}$$

The disturbance processing may be given by Formula (7) below.

$$\begin{matrix}y = x + {\sum }_{k = 1}^{N} {r}_{k} ⊙ {shuffle}_{k} ( x ) & ( 7 ) \\ N \text{:} NUMBER OF TIMES OF DISTURBANCE & \\ k \text{:} SUBSCRIPT OF EACH DISTURBANCE OPERATION & \end{matrix}$$

A random number related to each k is independently obtained. The backpropagation may be considered similarly to the case of the embodiment.

The disturbance processing may be given by Formula (8) below.

$$\begin{matrix}{y}_{i} = {x}_{i} + {\sum }_{j = 1}^{r ( N , i )} {r}_{ij} {x}_{p ( ij )} & ( 8 ) \\ i , j \text{:} SUBSCRIPT & \\ r ( N , i ) \text{:} RANDOM NUMBER GREATER THAN OR EQUAL TO ZERO & \\ p ( ij ) \text{:} SUBSCRIPT BETWEEN 1 AND k INCLUSIVE , RANDOMLY DETERMINED BY i AND j & \end{matrix}$$

In this case, since the data used for disturbance are randomly selected, randomness in the disturbance can be strengthened.

The disturbance processing may be given by Formula (9) below.

$$\begin{matrix}y = x + F ( r , shuffle ( x ) ) & ( 9 ) \\ F ( \cdot ) \text{:} DIFFERENTIABLE NON \text{-} LINEAR FUNCTION \\ ( SUCH AS SINE FUNCTION AND SQUARE FUNCTION ) & \end{matrix}$$

The disturbance processing may be given by Formula (10) below.

y=x+κ⊙ shuffle(x) (10)

κ: VECTOR OF A PREDETERMINED VALUE

### Second Modification

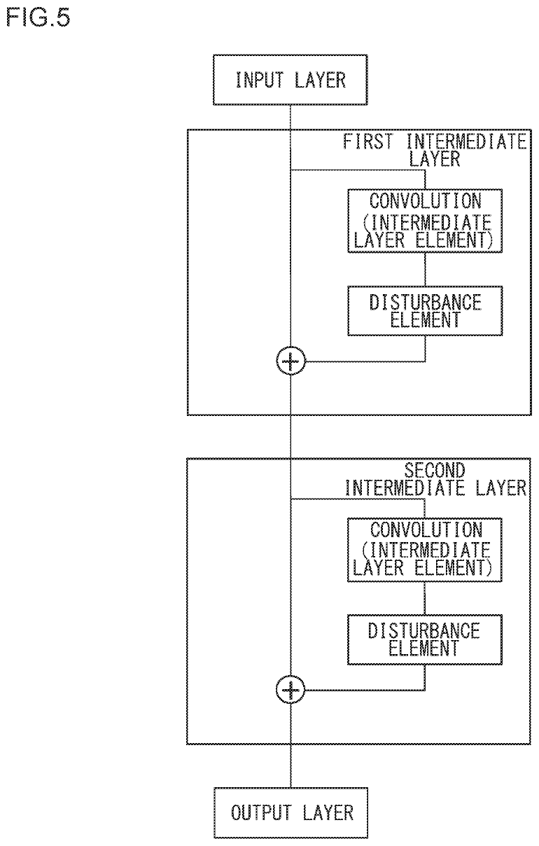

FIG. 5 schematically shows another example of the neural network configuration. In this example, a disturbance element is included after convolution processing. This corresponds to a disturbance element included after each convolution processing in residual networks or densely connected networks as conventional methods. In each intermediate layer, first intermediate data to be input to an intermediate layer element for performing convolution processing is integrated with second intermediate data obtained by performing disturbance processing on intermediate data output after the first intermediate data is input to the intermediate layer element. In other words, in each intermediate layer, an operation is performed to integrate an identity mapping path of which the input-output relation is given by identity mapping, and an optimization target path in which the optimization target parameter is included. The present modification adds disturbance to the optimization target path while maintaining the identity relation in the identity mapping path, enabling more stable learning.

### Third Modification

Although the embodiment does not particularly refer to, in Formula (1), σ may be monotonically increased according to the number of learning repetitions. This can restrain overtraining more effectively in a later phase of learning in which the learning can be stably performed.

What is claimed is:

1. A data processing system comprising a processor including hardware, wherein the processor is configured to
perform processing based on a neural network including an input layer, at least one intermediate layer, and an output layer,
optimize an optimization target parameter in the neural network, based on a comparison between output data output after the processor performs the processing on learning data and ideal output data for the learning data, and
perform, when intermediate data represent input data to an intermediate layer element constituting an Mth intermediate layer or output data from the intermediate layer element, disturbance processing of applying, to each of N intermediate data based on a set of N learning samples included in learning data, an operation using at least one intermediate datum selected from among the N intermediate data, where M is an integer greater than or equal to 1, and N is an integer greater than or equal to 2.

2. The data processing system according to claim 1, wherein, as disturbance processing, the processor is configured to linearly combine each of N intermediate data with at least one intermediate datum selected from among the N intermediate data.

3. The data processing system according to claim 2, wherein, as disturbance processing, the processor is configured to add, to each of N intermediate data, data obtained by multiplying at least one intermediate datum selected from among the N intermediate data by a random number.

4. The data processing system according to claim 1, wherein, as disturbance processing, the processor is configured to apply, to each of N intermediate data, an operation using at least one intermediate datum randomly selected from among the N intermediate data.

5. The data processing system according to claim 4, wherein, as disturbance processing, the processor is configured to apply, to an i-th intermediate datum among N intermediate data, an operation using an i-th intermediate datum among the N intermediate data of which the order is randomly rearranged, where i is an integer between 1 and N inclusive.

6. The data processing system according to claim 1, wherein the processor is configured to perform processing for integrating first intermediate data to be input to an intermediate layer element with second intermediate data obtained by performing disturbance processing on intermediate data output after the first intermediate data is input to the intermediate layer element.

7. The data processing system according to claim 1, wherein the processor is configured not to perform disturbance processing during application processing.

8. The data processing system according to claim 2, wherein, in application processing, instead of disturbance processing, the processor is configured to output a result of multiplying an expected value of a coefficient by which an i-th intermediate datum among N intermediate data is multiplied, with the i-th intermediate datum as output data for the i-th intermediate datum.

9. A data processing method, comprising:
performing processing based on a neural network including an input layer, at least one intermediate layer, and an output layer; and
optimizing an optimization target parameter in the neural network, based on a comparison between output data output after the processor performs the processing on learning data and ideal output data for the learning data, wherein,
in the optimizing, when intermediate data represent input data to an intermediate layer element constituting an Mth intermediate layer or output data from the intermediate layer element, disturbance processing of applying, to each of N intermediate data based on a set of N learning samples included in learning data, an operation using at least one intermediate datum selected from among the N intermediate data is performed, where M is an integer greater than or equal to 1, and N is an integer greater than or equal to 2.

10. A non-transitory computer readable medium encoded with a program executable by a computer, the program comprising:
performing processing based on a neural network including an input layer, at least one intermediate layer, and an output layer;
optimizing an optimization target parameter in the neural network, based on a comparison between output data output after the processor performs the processing on learning data and ideal output data for the learning data; and
performing, when intermediate data represent input data to an intermediate layer element constituting an Mth intermediate layer or output data from the intermediate layer element, disturbance processing of applying, to each of N intermediate data based on a set of N learning samples included in learning data, an operation using at least one intermediate datum selected from among the N intermediate data, where M is an integer greater than or equal to 1, and N is an integer greater than or equal to 2.
